(19) United States
(12) Patent Application Publication
(10) Pub. No.: US 2019/0042899 A1
(43) Pub. Date: Feb. 7, 2019

(54) Two-dimensional Symbols For Facilitating Machine Learning Of Combined Meaning Of Multiple Ideograms Contained Therein

(71) Applicant: GYRFALCON TECHNOLOGY INC., Milpitas, CA (US)

(72) Inventors: Lin Yang, Milpitas, CA (US); Patrick Z. Dong, San Jose, CA (US); Baohua Sun, Fremont, CA (US)

(21) Appl. No.: 15/683,723

(22) Filed: Aug. 22, 2017

Related U.S. Application Data
(60) Provisional application No. 62/541,081, filed on Aug. 3, 2017.

(51) Int. Cl. G06K 9/66; G06N 3/08; G06K 9/46

(52) U.S. Cl. CPC G06K 9/66; G06N 3/08; G06K 2209/013; G06K 2209/011; G06K 9/4628

(57) ABSTRACT

Two-dimensional symbols with each containing multiple ideograms for facilitating machine learning are disclosed. Two-dimensional symbol comprises a matrix of N×N pixels of data representing a “super-character”. The matrix is divided into M×M sub-matrices with each of the sub-matrices containing (N/M)×(N/M) pixels. N and M are positive integers or whole numbers, and N is preferably a multiple of M. Each of the sub-matrices represents one ideogram defined in an ideogram collection set. “Super-character” represents at least one meaning each formed with a specific combination of a plurality of ideograms. Ideogram collection set includes, but is not limited to, pictograms, logosyllabic characters, Japanese characters, Korean characters, punctuation marks, numerals, special characters. Logosyllabic characters may contain one or more of Chinese characters, Japanese characters, Korean characters. Features of each ideogram can be represented by more than one layer of two-dimensional symbol.

### CROSS-REFERENCE TO RELATED APPLICATIONS

This application claims priority from a co-pending U.S. Provisional Patent Application Ser. No. 62/541,081, entitled “Two-dimensional Symbol For Facilitating Machine Learning Of Natural Languages Having Logosyllabic Characters” filed on Aug. 3, 2017. The contents of which are incorporated by reference in its entirety for all purposes.

This application is related to a co-pending U.S. patent application Ser. No. 15/683,717 for “Two-dimensional Symbols For Facilitating Machine Learning Of Written Chinese Language Using Logosyllabic Characters” filed on Aug. 22, 2017 by the same inventors.

### FIELD

The invention generally relates to the field of machine learning and more particularly to two-dimensional symbols for facilitating machine learning of combined meaning of multiple ideograms contained therein.

### BACKGROUND

An ideogram is a graphic symbol that represents an idea or concept. Some ideograms are comprehensible only by familiarity with prior convention; others convey their meaning through pictorial resemblance to a physical object.

Machine learning is an application of artificial intelligence. In machine learning, a computer or computing device is programmed to think like human beings so that the computer may be taught to learn on its own. The development of neural networks has been key to teaching computers to think and understand the world in the way human beings do. One particular implementation is referred to as Cellular Neural Networks or Cellular Nonlinear Networks (CNN) based computing system. CNN based computing system has been used in many different fields and problems including, but not limited to, image processing.

### SUMMARY

This section is for the purpose of summarizing some aspects of the invention and to briefly introduce some preferred embodiments. Simplifications or omissions in this section as well as in the abstract and the title herein may be made to avoid obscuring the purpose of the section. Such simplifications or omissions are not intended to limit the scope of the invention.

Two-dimensional symbols for facilitating machine learning of combined meaning of multiple ideograms contained therein are disclosed. Two-dimensional symbol comprises a matrix of N×N pixels of data representing a “super-character”. The matrix is divided into M×M sub-matrices with each of the sub-matrices containing (N/M)×(N/M) pixels. N and M are positive integers or whole numbers, and N is preferably a multiple of M. Each of the sub-matrices represents one ideogram defined in an ideogram collection set. “Super-character” represents at least one meaning each formed with a specific combination of a plurality of ideograms. Ideogram collection set includes, but is not limited to, pictograms, logosyllabic characters, Japanese characters, Korean characters, punctuation marks, numerals, special characters. Logosyllabic characters may contain one or more of Chinese characters, Japanese characters, Korean characters. Features of each ideogram can be represented by more than one layer of two-dimensional symbol.

One of the objectives, features and advantages of the invention is to use a two-dimensional symbol for representing more than individual ideogram, logosyllabic script or character. Such a two-dimensional symbol facilitates a CNN based computing system to learn the meaning of a specific combination of a plurality of ideograms contained in a “super-character” using image processing techniques, e.g., convolutional neural networks, recurrent neural networks, etc.

Other objects, features, and advantages of the invention will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIG. 1 is a diagram illustrating an example two-dimensional symbol comprising a matrix of N×N pixels of data that represents a “super-character” for facilitating machine learning of a combined meaning of multiple ideograms contained therein according to an embodiment of the invention;

FIGS. 2A-2B are diagrams showing example partition schemes for dividing the two-dimensional symbol of FIG. 1 in accordance with embodiments of the invention;

FIGS. 3A-3B show example ideograms in accordance with an embodiment the invention;

FIG. 3C shows example pictograms containing western languages based on Latin letters in accordance with an embodiment of the invention;

FIG. 3D shows three respective basic color layers of an example ideogram in accordance with an embodiment of the invention;

FIG. 3E shows three related layers of an example ideogram for dictionary-like definition in accordance with an embodiment of the invention; and

FIG. 4 is block diagram illustrating an example Cellular Neural Networks or Cellular Nonlinear Networks (CNN) based computing system for machine learning of a combined meaning of multiple ideograms contained in a two-dimensional symbol, according to one embodiment of the invention.

### DETAILED DESCRIPTIONS

In the following description, numerous specific details are set forth in order to provide a thorough understanding of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Used herein, the terms “vertical”, “horizontal”, “diagonal”, “left”, “right”, “top”, “bottom”, “column”, “row”, “diagonally” are intended to provide relative positions for the purposes of description, and are not intended to designate an absolute frame of reference. Additionally, used herein, term “character” and “script” are used interchangeably.

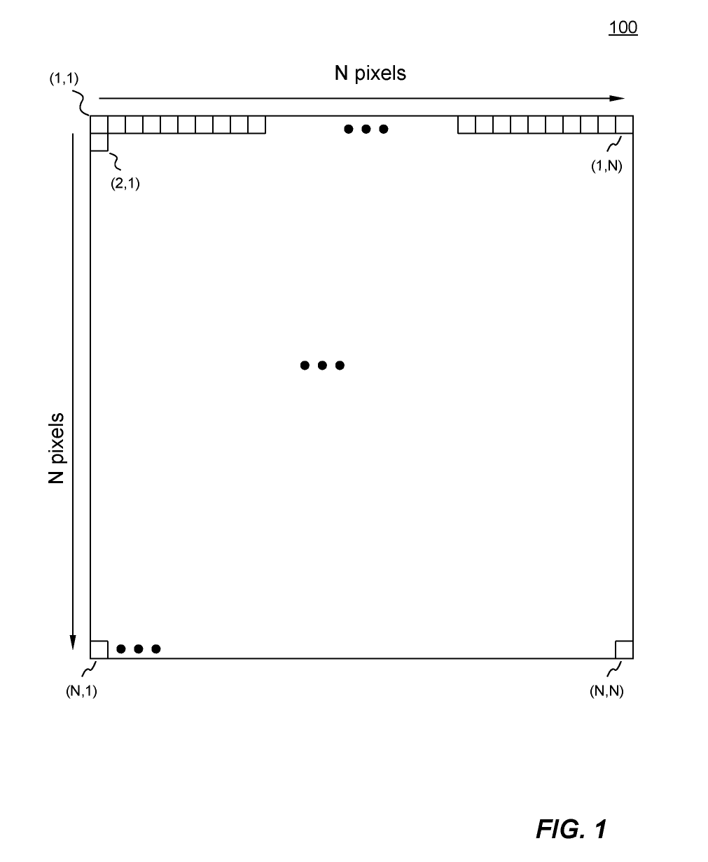

Embodiments of the invention are discussed herein with reference to FIGS. 1-4. However, those skilled in the art will readily appreciate that the detailed description given herein with respect to these figures is for explanatory purposes as the invention extends beyond these limited embodiments.

Referring first to FIG. 1, it is shown a diagram showing an example two-dimensional symbol 100 for facilitating machine learning of a combined meaning of multiple ideograms contained therein. The two-dimensional symbol 100 comprises a matrix of N×N pixels (i.e., N columns by N rows) of data containing a “super-character”. Pixels are ordered with row first and column second as follows: (1,1), (1,2), (1,3), . . . (1,N), (2,1), . . . , (N,1), (N,N). N is a positive integer or whole number, for example in one embodiment, N is equal to 224.

“Super-character” represents at least one meaning each formed with a specific combination of a plurality of ideograms. Since an ideogram can be represented in a certain size matrix of pixels, two-dimensional symbol 100 is divided into M×M sub-matrices. Each of the sub-matrices represents one ideogram, which is defined in an ideogram collection set by humans. “Super-character” contains a minimum of two and a maximum of M×M ideograms. Both N and M are positive integers or whole numbers, and N is preferably a multiple of M.

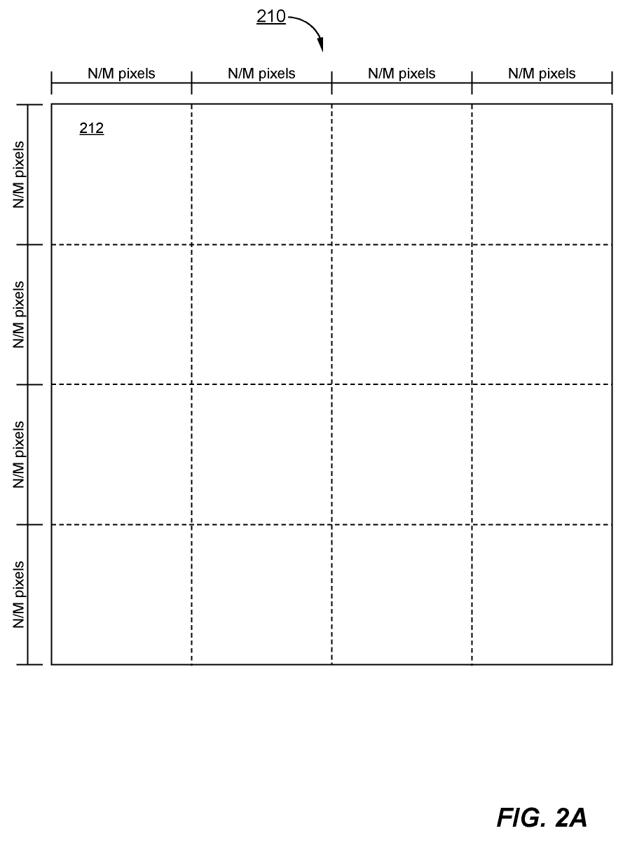

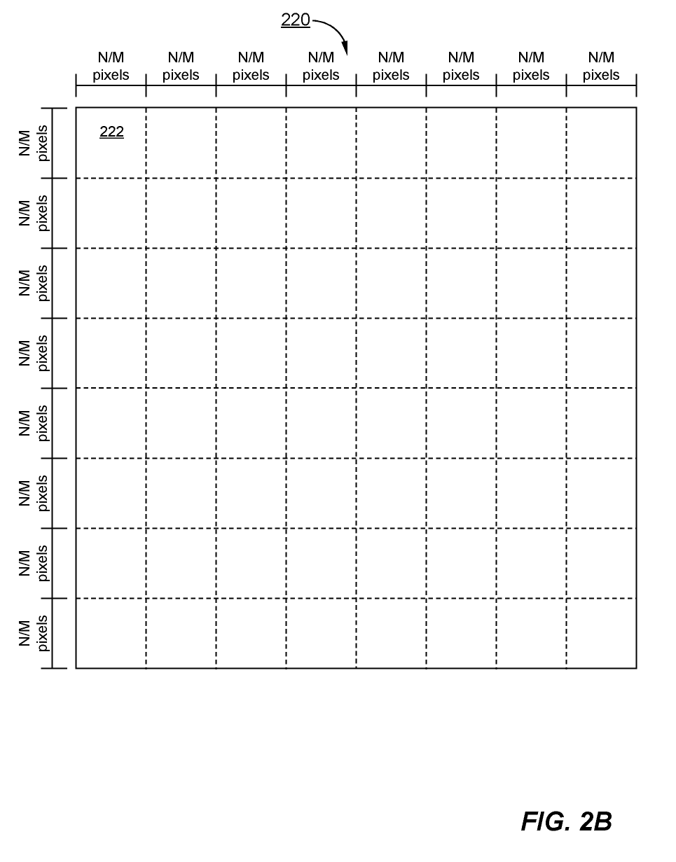

Shown in FIG. 2A, it is a first example partition scheme 210 of dividing a two-dimension symbol into M×M sub-matrices 212. M is equal to 4 in the first example partition scheme. Each of the M×M sub-matrices 212 contains (N/M)×(N/M) pixels. When N is equal to 224, each sub-matrix contains 56×56 pixels and there are 16 submatrices.

A second example partition scheme 220 of dividing a two-dimension symbol into M×M sub-matrices 222 is shown in FIG. 2B. M is equal to 8 in the second example partition scheme. Each of the M×M sub-matrices 222 contains (N/M)×(N/M) pixels. When N is equal to 224, each sub-matrix contains 28×28 pixels and there are 64 submatrices.

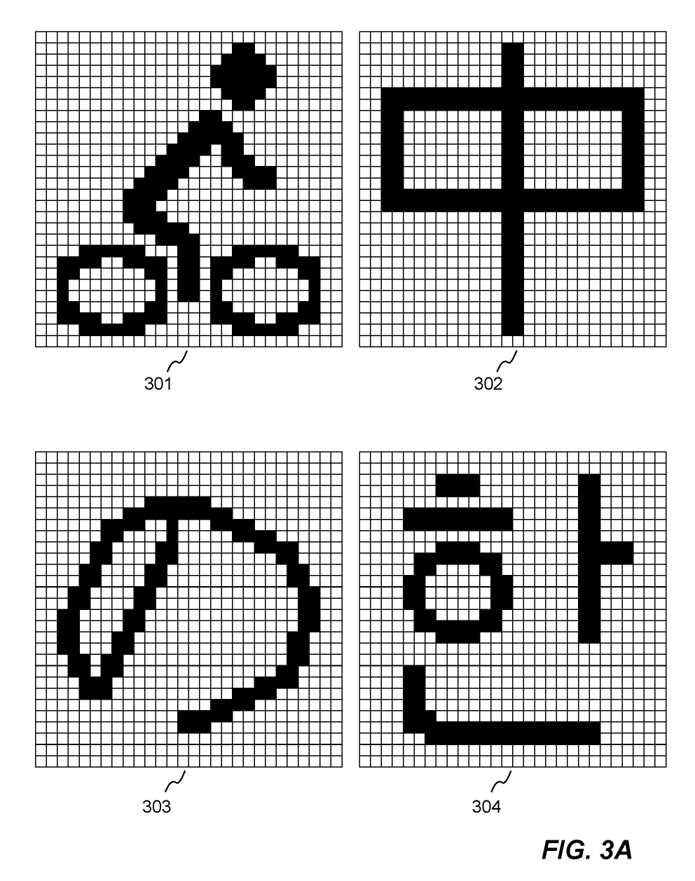

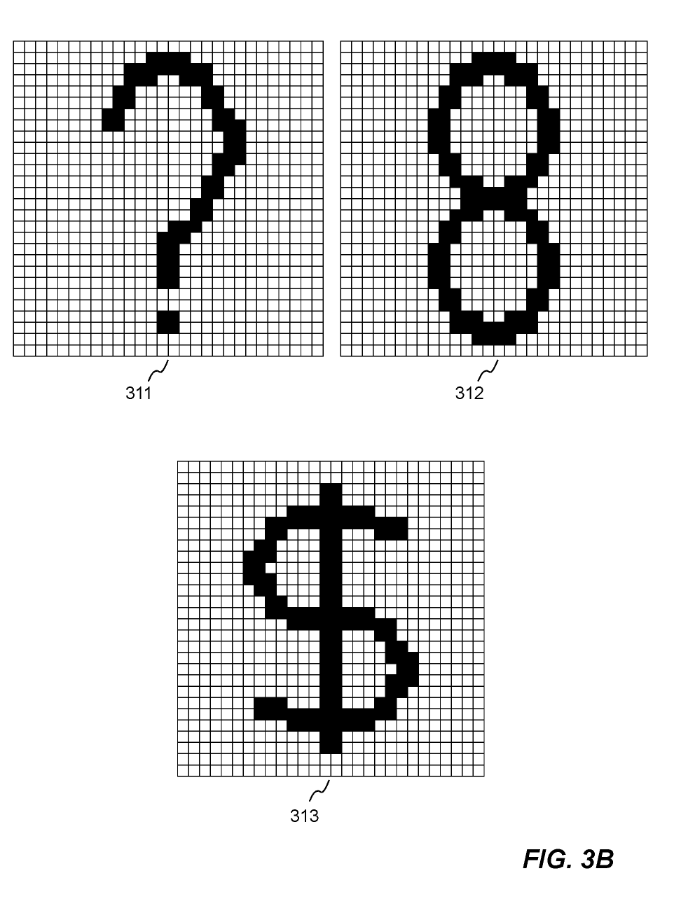

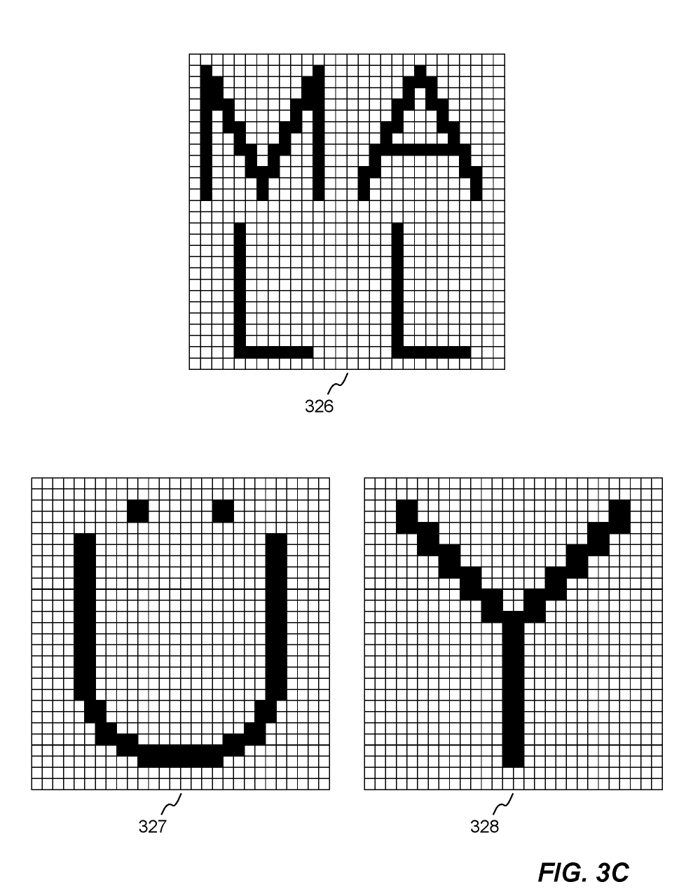

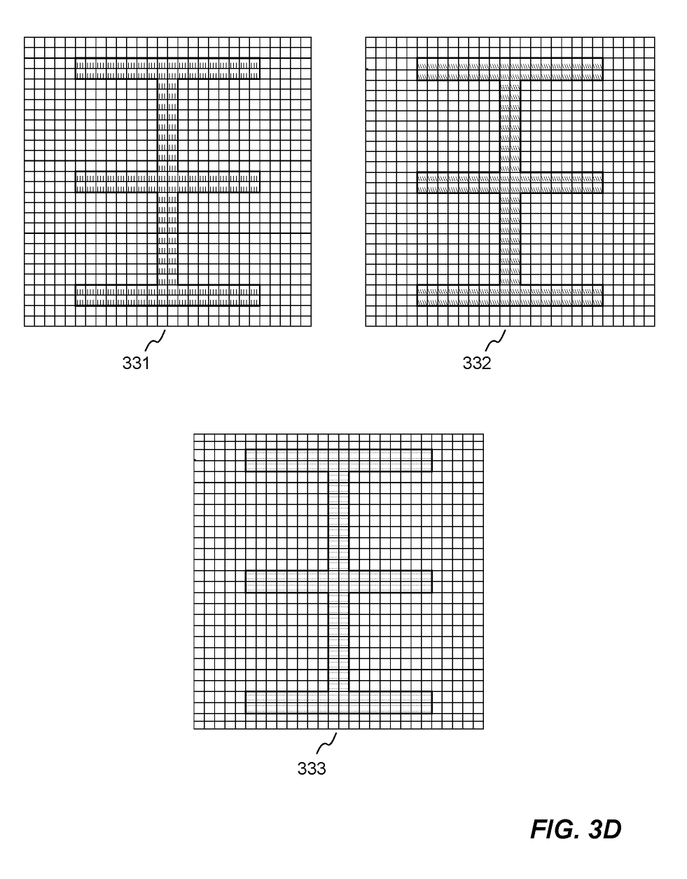

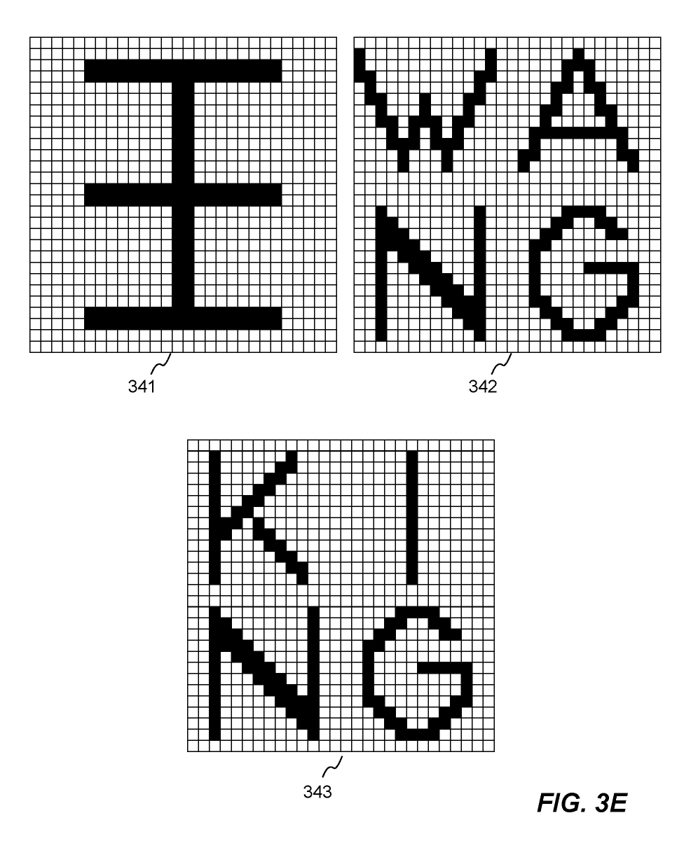

FIG. 3A shows example ideograms 301-304 that can be represented in a sub-matrix 222 (i.e., 28×28 pixels). For those having ordinary skill in the art would understand that the sub-matrix 212 having 56×56 pixels can also be adapted for representing these ideograms. The first example ideogram 301 is a pictogram representing an icon of a person riding a bicycle. The second example ideogram 302 is a logosyllabic script or character representing an example Chinese character. The third example ideogram 303 is a logosyllabic script or character representing an example Japanese character and the fourth example ideogram 304 is a logosyllabic script or character representing an example Korean character. Additionally, ideogram can also be punctuation marks, numerals or special characters. In another embodiment, pictogram may contain an icon of other images. Icon used herein in this document is defined by humans as a sign or representation that stands for its object by virtue of a resemblance or analogy to it.

FIG. 3B shows several example ideograms representing: a punctuation mark 311, a numeral 312 and a special character 313. Furthermore, pictogram may contain one or more words of western languages based on Latin letters, for example, English, Spanish, French, German, etc. FIG. 3C shows example pictograms containing western languages based on Latin letters. The first example pictogram 326 shows an English word “MALL”. The second example pictogram 327 shows a Latin letter “U” and the third example pictogram 328 shows English alphabet “Y”. Ideogram can be any one of them, as long as the ideogram is defined in the ideogram collection set by humans.

Only limited number of features of an ideogram can be represented using one single two-dimensional symbol. For example, features of an ideogram can be black and white when data of each pixel contains one-bit. Feature such as grayscale shades can be shown with data in each pixel containing more than one-bit.

Additional features are represented using two or more layers of an ideogram. In one embodiment, three respective basic color layers of an ideogram (i.e., red, green and blue) are used collectively for representing different colors in the ideogram. Data in each pixel of the two-dimensional symbol contains a K-bit binary number. K is a positive integer or whole number. In one embodiment, K is 5.

FIG. 3D shows three respective basic color layers of an example ideogram. Ideogram of a Chinese character are shown with red 331, green 332 and blue 333. With different combined intensity of the three basic colors, a number of color shades can be represented. Multiple color shades may exist within an ideogram.

In another embodiment, three related ideograms are used for represent other features such as a dictionary-like definition of a Chinese character shown in FIG. 3E. There are three layers for the example ideogram in FIG. 3E: the first layer 341 showing a Chinese logosyllabic character, the second layer 342 showing the Chinese “pinyin” pronunciation as “wang”, and the third layer 343 showing the meaning in English as “king”.

Ideogram collection set includes, but is not limited to, pictograms, logosyllabic characters, punctuation marks, numerals, special characters. Logosyllabic characters may contain one or more of Chinese characters, Japanese characters, Korean characters, etc.

In order to systematically include Chinese characters, a standard Chinese character set (e.g., GB18030) may be used as a start for the ideogram collection set. For including Japanese and Korean characters, CJK Unified Ideographs may be used. Other character sets for logosyllabic characters or scripts may also be used.

A specific combined meaning of ideograms contained in a “super-character” is a result of using image processing techniques in a Cellular Neural Networks or Cellular Nonlinear Networks (CNN) based computing system. Image processing techniques include, but are not limited to, convolutional neural networks, recurrent neural networks, etc.

“Super-character” represents a combined meaning of at least two ideograms out of a maximum of M×M ideograms. In one embodiment, a pictogram and a Chinese character are combined to form a specific meaning. In another embodiment, two or more Chinese characters are combined to form a meaning. In yet another embodiment, one Chinese character and a Korean character are combined to form a meaning. There is no restriction as to which two or more ideograms to be combined.

Ideograms contained in a two-dimensional symbol for forming “super-character” can be arbitrarily located. No specific order within the two-dimensional symbol is required. Ideograms can be arranged left to right, right to left, top to bottom, bottom to top, or diagonally.

Using written Chinese language as an example, combining two or more Chinese characters may result in a “super-character” including, but not limited to, phrases, idioms, proverbs, poems, sentences, paragraphs, written passages, articles (i.e., written works). In certain instances, the “super-character” may be in a particular area of the written Chinese language. The particular area may include, but is not limited to, certain folk stories, historic periods, specific background, etc.

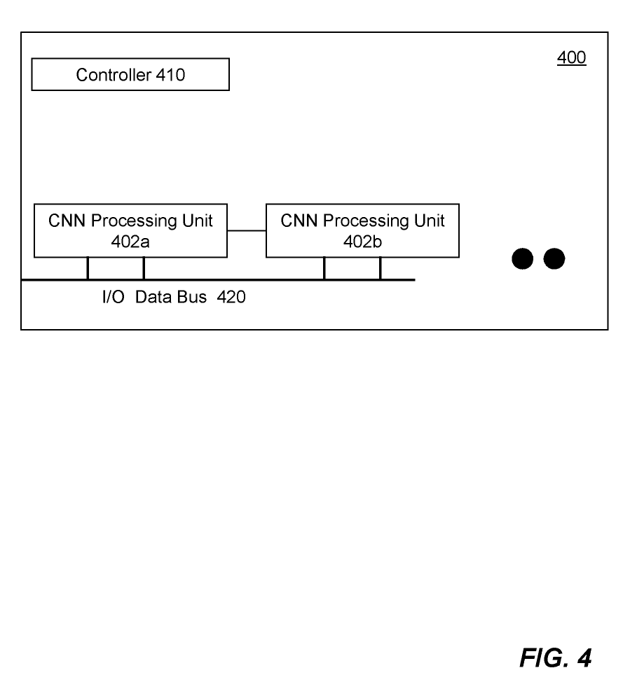

Referring now to FIG. 4, it is shown a block diagram illustrating an example CNN based computing system 400 configured for machine learning of a combined meaning of multiple ideograms contained in a two-dimensional symbol (e.g., the two-dimensional symbol 100).

The CNN based computing system 400 may be implemented on integrated circuits as a digital semi-conductor chip (e.g., a silicon substrate) and contains a controller 410, and a plurality of CNN processing units 402a-402b operatively coupled to at least one input/output (I/O) data bus 420. Controller 410 is configured to control various operations of the CNN processing units 402a-402b, which are connected in a loop with a clock-skew circuit.

In one embodiment, each of the CNN processing units 402a-402b is configured for processing imagery data, for example, two-dimensional symbol 100 of FIG. 1.

In another embodiment, the CNN based computing system is a digital integrated circuit that can be extendable and scalable. For example, multiple copies of the digital integrated circuit may be implemented on a single semi-conductor chip.

To store an ideogram collection set, one or more storage units operatively coupled to the CNN based computing system 400 are required. Storage units (not shown) can be located either inside or outside the CNN based computing system 400 based on well known techniques.

“Super-character” may contain more than one meanings in certain instances. “Super-character” can tolerate certain errors that can be corrected with error-correction techniques. In other words, the pixels represent ideograms do not have to be exact. The errors may have different causes, for example, data corruptions, during data retrieval, etc.

Although the invention has been described with reference to specific embodiments thereof, these embodiments are merely illustrative, and not restrictive of, the invention. Various modifications or changes to the specifically disclosed example embodiments will be suggested to persons skilled in the art. For example, whereas the two-dimensional symbol has been described and shown with a specific example of a matrix of 224×224 pixels, other sizes may be used for achieving substantially similar objections of the invention. Additionally, whereas two example partition schemes have been described and shown, other suitable partition scheme of dividing the two-dimensional symbol may be used for achieving substantially similar objections of the invention. Moreover, few example ideograms have been shown and described, other ideograms may be used for achieving substantially similar objectives of the invention. Finally, whereas Chinese, Japanese and Korean logosyllabic characters have been described and shown to be an ideogram, other logosyllabic characters can be represented, for example, Egyptian hieroglyphs, Cuneiform scripts, etc. In summary, the scope of the invention should not be restricted to the specific example embodiments disclosed herein, and all modifications that are readily suggested to those of ordinary skill in the art should be included within the spirit and purview of this application and scope of the appended claims.

What is claimed is:

1. A two-dimensional symbol for facilitating machine learning comprising:
a matrix of N×N pixels of data containing a “super-character”, the matrix being divided into M×M sub-matrices with each of the sub-matrices containing (N/M)×(N/M) pixels, where N and M are positive integers or whole numbers, and N is a multiple of M; and
said each of the sub-matrices representing one ideogram defined in an ideogram collection set, and the “super-character” representing at least one meaning each formed with a specific combination of a plurality of ideograms.

2. The two-dimensional symbol of claim 1, wherein the “super-character” is extracted out of the matrix in a Cellular Neural Networks or Cellular Nonlinear Networks (CNN) based computing system using an image processing technique.

3. The two-dimensional symbol of claim 2, wherein the image processing technique comprises a convolutional neural networks algorithm.

4. The two-dimensional symbol of claim 3, wherein the CNN based computing system comprises a semi-conductor chip containing digital circuits dedicated for performing the convolutional neural networks algorithm.

5. The two-dimensional symbol of claim 1, wherein the “super-character” comprises a minimum of two and a maximum of M×M ideograms.

6. The two-dimensional symbol of claim 1, wherein the ideogram collection set comprises pictograms, logosyllabic characters, punctuation marks, numerals and special characters defined by humans.

7. The two-dimensional symbol of claim 6, wherein the pictograms comprise icons.

8. The two-dimensional symbol of claim 6, wherein the pictograms comprise one or more Latin letters.

9. The two-dimensional symbol of claim 6, wherein the logosyllabic characters comprise Chinese characters.

10. The two-dimensional symbol of claim 6, wherein the logosyllabic characters comprise Japanese characters.

11. The two-dimensional symbol of claim 6, wherein the logosyllabic characters comprise Korean characters.

12. The two-dimensional symbol of claim 6, wherein the logosyllabic characters comprise Egyptian hierographs.

13. The two-dimensional symbol of claim 6, wherein the logosyllabic characters comprise Cuneiform scripts.

14. The two-dimensional symbol of claim 1, wherein N is 224, M is 4 and N/M is 56.

15. The two-dimensional symbol of claim 1, wherein N is 224, M is 8 and N/M is 28.

16. The two-dimensional symbol of claim 1, wherein each ideogram comprises at least one feature.

17. The two-dimensional symbol of claim 16, wherein the at least one feature comprises black and white, which is achieved with each of the N×N pixels to contain one-bit of the data.

18. The two-dimensional symbol of claim 16, wherein the at least one feature comprises grayscale shades, which is achieved each of the N×N pixels to contain more than one-bit of the data.

19. The two-dimensional symbol of claim 16, wherein the at least one feature comprises different colors, which is achieved with three respective basic color layers of said each ideogram and, with each of the N×N pixels to contain K-bit of the data, where K is a positive integer or whole number.

20. The two-dimensional symbol of claim 16, wherein the at least one feature comprises a dictionary-like definition, which is achieved using three related layers of said each ideogram with the first layer showing logosyllabic Chinese character, the second layer showing Chinese “pinyin” for pronunciation and the third layer showing a meaning in English.
